(19) United States
(12) Patent Application Publication
(10) Pub. No.: US 2025/0054692 A1
(43) Pub. Date: Feb. 13, 2025

(54) MULTILAYER ELECTRONIC COMPONENT

(71) Applicant: SAMSUNG ELECTRO-MECHANICS CO., LTD., Suwon-si (KR)

(72) Inventor: Dongseuk KIM, Suwon-si (KR)

(73) Assignee: SAMSUNG ELECTRO-MECHANICS CO., LTD., Suwon-si (KR)

(21) Appl. No.: 18/644,372

(22) Filed: Apr. 24, 2024

(30) Foreign Application Priority Data
Aug. 11, 2023 (KR) 10-2023-0105577

(51) Int. Cl. H01G 4/012; H01G 4/12; H01G 4/30

(52) U.S. Cl. CPC H01G 4/012; H01G 4/30; H01G 4/1227; H01G 4/1236

(57) ABSTRACT

A multilayer electronic component includes a body including a dielectric layer, a first internal electrode layer, and a second internal electrode layer alternately disposed in a first direction; first and second external electrodes respectively disposed on surfaces of the body in a second direction. The first internal electrode layer includes first internal electrodes connected to the first external electrode, and the second internal electrode layer includes a second internal electrodes connected to the second external electrode. The first and second internal electrodes are alternately disposed in a third direction, the first internal electrodes of the first internal electrode layer are alternately disposed with the second internal electrodes of the second internal electrode layer in the first direction, and the second internal electrodes of the first internal electrode layer are alternately disposed with the first internal electrodes of the second internal electrode layer in the first direction.

### CROSS-REFERENCE TO RELATED APPLICATION(S)

This application claims benefit of priority to Korean Patent Application No. 10-2023-0105577 filed on Aug. 11, 2023 in the Korean Intellectual Properties Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, may be a chip-type condenser mounted on the printed circuit boards of various types of electronic products, such as an image display device such as a liquid crystal display (LCD) or a plasma display panel (PDP), a computer, a smartphone, a mobile phone, and the like, serving to charge or discharge electricity therein or therefrom.

As electronic products have been designed to have a reduced size, thickness and multi-functionality, chip components have also been required to have a reduced size, and mounting of electronic components has also become highly integrated. In response to this trend, a space between mounted electronic components has also been reduced.

In order for an MLCC to have high capacitance, it may be necessary to use a material with a high dielectric constant as a material of a dielectric layer, or design to reduce a thickness of the dielectric layer. However, MLCC has many characteristics which should be satisfied at the same time, such as temperature characteristics, voltage characteristics, and moisture-resistance reliability, in addition to capacitance, so there is a limit to reducing the thickness of the dielectric layer.

Therefore, there is a need for structural improvement of MLCC that can improve capacitance per unit volume without deteriorating reliability.

### SUMMARY

An aspect of the present disclosure is to improve capacitance per unit volume of a multilayer electronic component.

An aspect of the present disclosure is to improve capacitance per unit volume of a multilayer electronic component without deteriorating reliability thereof.

According to an aspect of the present disclosure, a multilayer electronic component may include: a body including a dielectric layer, a first internal electrode layer, and a second internal electrode layer alternately disposed in a first direction, with the dielectric layer interposed therebetween; a first external electrode disposed on one surface of two surfaces of the body opposing each other in a second direction, perpendicular to the first direction; and a second external electrode disposed on the other surface of two surfaces of the body opposing each other in the second direction. The first internal electrode layer may include first internal electrodes connected to the first external electrode, and the second internal electrode layer may include second internal electrodes connected to the second external electrode. The first and second internal electrodes may be alternately disposed to be spaced apart from each other in a third direction, perpendicular to the first and second directions, the first internal electrodes of the first internal electrode layer may be alternately disposed with the second internal electrodes of the second internal electrode layer in the first direction, and the second internal electrodes of the first internal electrode layer may be alternately disposed with the first internal electrodes of the second internal electrode layer in the first direction. s≥td may be satisfied, in which s is a distance in the third direction between one of the first internal electrodes and a second internal electrode, most adjacent to the one of the first internal electrodes in the third direction and td is a distance in the first direction between the one of the first internal electrodes and a second internal electrode, most adjacent to the one of the first internal electrode in the first direction.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective view schematically illustrating a multilayer electronic component according to an embodiment of the present disclosure;

FIG. 2 is a perspective view schematically illustrating a body according to an embodiment;

FIG. 3 is a cross-sectional view illustrating a cross-section of a multilayer electronic component in a first direction and a third direction polished to a central portion of the multilayer electronic component in a second direction according to a comparative example;

FIG. 4 is a cross-sectional view taken along line I-I′ of FIG. 1;

FIG. 5 is a plan view illustrating an internal electrode layer according to an embodiment;

FIG. 6 is a cross-sectional view illustrating a cross-section of a capacitance forming portion in a first direction and a third direction according to an embodiment;

FIG. 7A is a schematic diagram illustrating an electric field flux between internal electrodes of a multilayer electronic component according to a comparative example using a (3×n) matrix as an example, and FIG. 7B is a schematic diagram illustrating an electric field flux between internal electrodes of a multilayer electronic component according to an example using a (3×n) matrix as an example;

FIG. 8A is a schematic diagram illustrating an electric field flux between internal electrodes of a multilayer electronic component according to a comparative example using a (n×3) matrix as an example, and FIG. 8B is a schematic diagram illustrating an electric field flux between internal electrodes of a multilayer electronic component according to an example using a (n 3) matrix as an example;

FIG. 9 is an enlarged view of area P in FIG. 4; and

FIG. 10 is a perspective view illustrating a portion of a process of stacking internal electrodes and a dielectric layer according to an embodiment.

### DETAILED DESCRIPTION

Hereinafter, specific embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, a first direction may be defined as a direction in which first and second internal electrodes are alternately disposed with a dielectric layer interposed therebetween or a thickness T direction, and among second and third directions perpendicular to the first direction, the second direction may be defined as a length L direction, and the third direction may be defined as a width W direction.

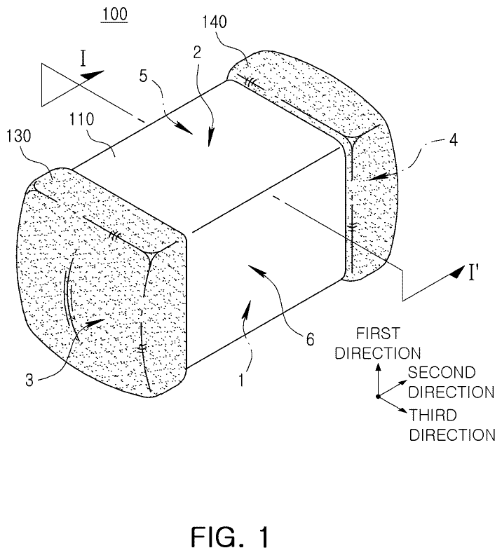

FIG. 1 is a perspective view schematically illustrating a multilayer electronic component according to an embodiment of the present disclosure.

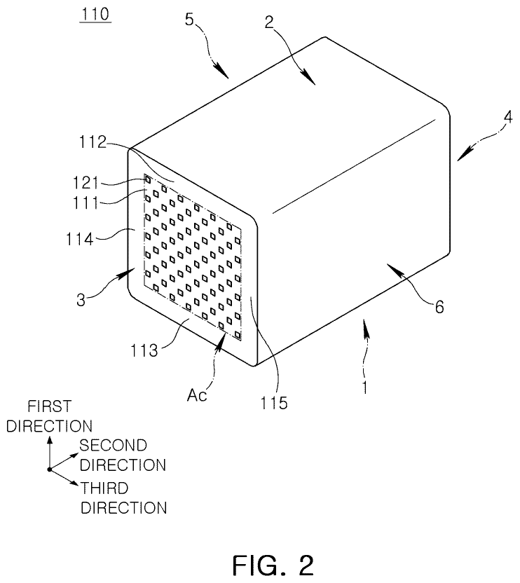

FIG. 2 is a perspective view schematically illustrating a body according to an embodiment.

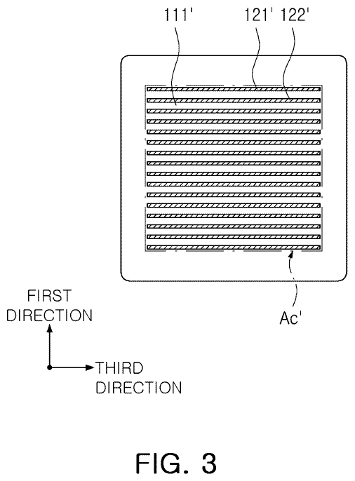

FIG. 3 is a cross-sectional view illustrating a cross-section of a multilayer electronic component in a first direction and a third direction polished to a central portion of the multilayer electronic component in a second direction according to a comparative example.

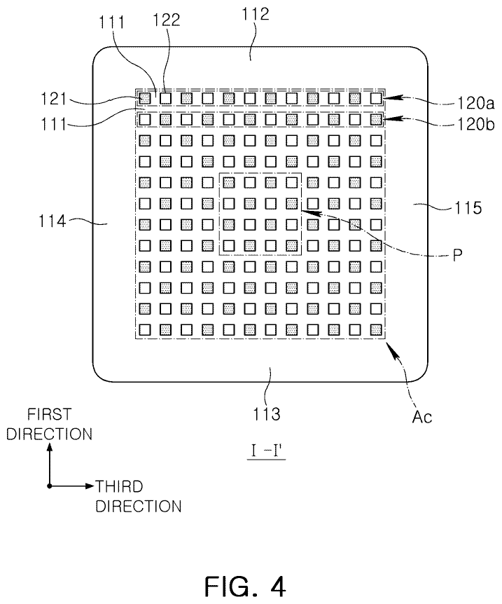

FIG. 4 is a cross-sectional view taken along line I-I′ of FIG. 1.

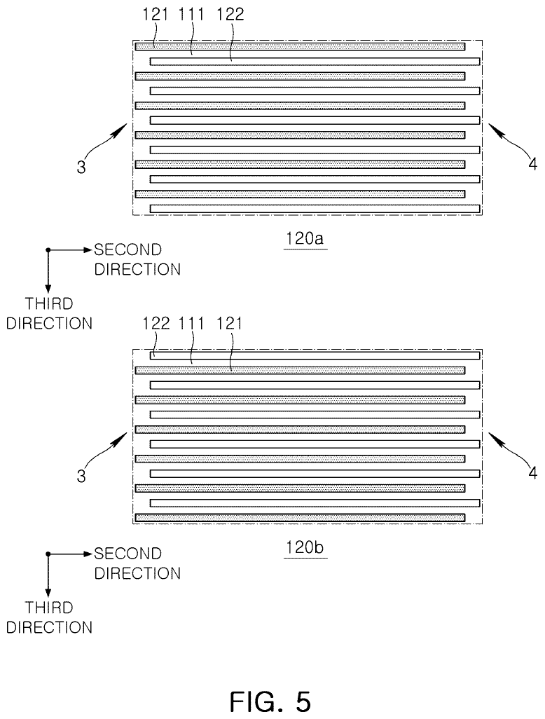

FIG. 5 is a plan view illustrating an internal electrode layer according to an embodiment.

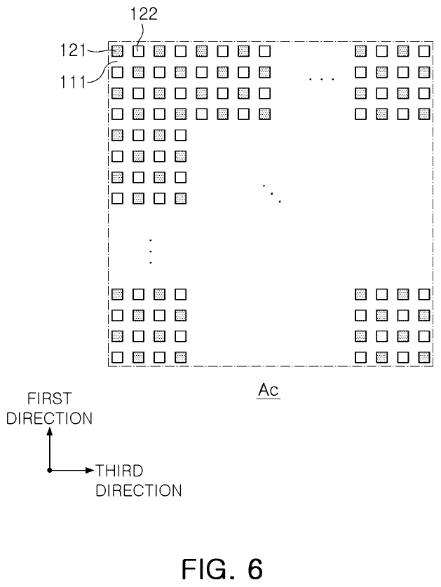

FIG. 6 is a cross-sectional view illustrating a cross-section of a capacitance forming portion in a first direction and a third direction.

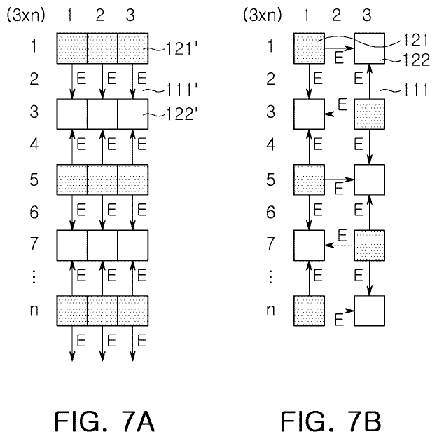

FIG. 7A is a schematic diagram illustrating an electric field flux between internal electrodes of a multilayer electronic component according to a comparative example using a (3×n) matrix as an example, and FIG. 7B is a schematic diagram illustrating an electric field flux between internal electrodes of a multilayer electronic component according to an example using a (3×n) matrix as an example.

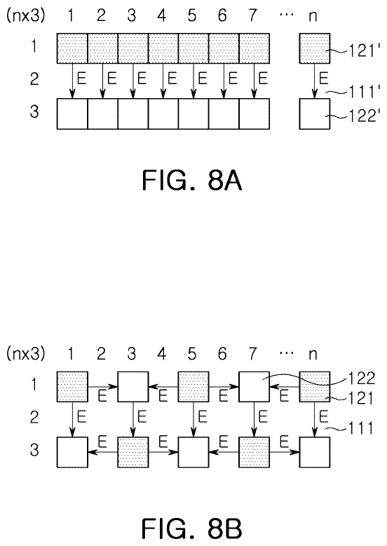

FIG. 8A is a schematic diagram illustrating an electric field flux between internal electrodes of a multilayer electronic component according to a comparative example using a (n×3) matrix as an example, and FIG. 8B is a schematic diagram illustrating an electric field flux between internal electrodes of a multilayer electronic component according to an example using a (n X 3) matrix as an example.

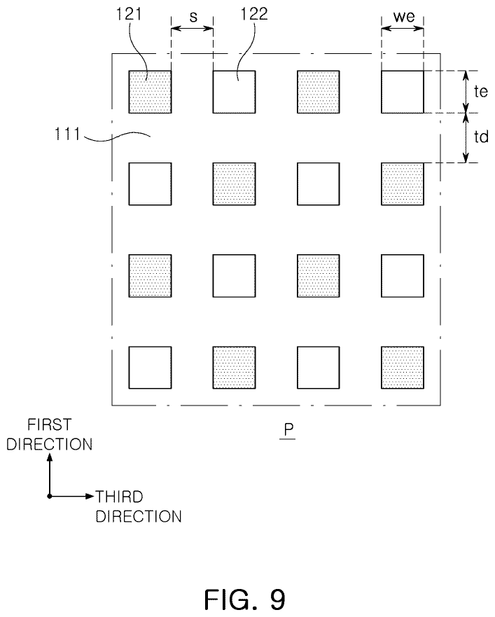

FIG. 9 is an enlarged view of area P in FIG. 4.

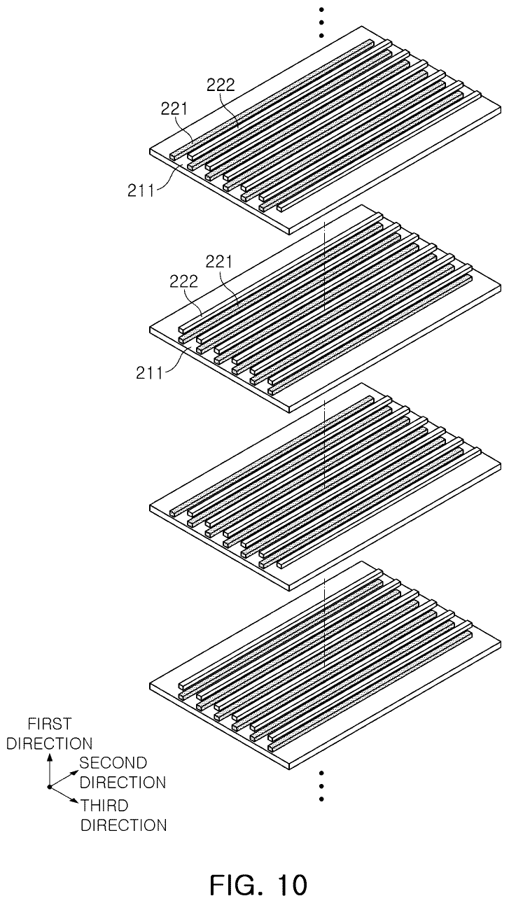

FIG. 10 is a perspective view illustrating a portion of a process of stacking internal electrodes and a dielectric layer according to an embodiment.

Hereinafter, a multilayer electronic component 100 according to embodiments will be described in greater detail with reference to FIGS. 1 to 10.

According to an embodiment of the present disclosure, a multilayer electronic component 100 may include a body including a dielectric layer 111, a first internal electrode layer 120a, and a second internal electrode layer 120b alternately disposed in a first direction with the dielectric layer 111 interposed therebetween; a first external electrode 130 disposed on one surface of two surfaces of the body opposing each other in a second direction, perpendicular to the first direction; and a second external electrode 140 disposed on the other surface of two surfaces of the body opposing each other in the second direction. The first internal electrode layer 120a may include a first internal electrode 121 connected to the first external electrode 130, and the second internal electrode layer 120b may include a second internal electrode 122 connected to the second external electrode 140. The first and second internal electrodes 121 and 122 may be alternately disposed to be spaced apart from each other in a third direction, perpendicular to the first and second directions, the first internal electrode 121 of the first internal electrode layer 120a may be alternately disposed with the second internal electrode 122 of the second internal electrode layer 120b in the first direction, and the second internal electrode 122 of the first internal electrode layer 120a may be alternately disposed with the first internal electrode 121 of the second internal electrode layer 120b in the first direction. When a distance in the third direction between the first internal electrode 121 and a second internal electrode 122, most adjacent to the first internal electrode 121 in the third direction is defined as s, and a distance in the first direction between the first internal electrode 121 and a second internal electrode 122, most adjacent to the first internal electrode 121 in the first direction is defined as td, s≥td is satisfied.

Referring to FIG. 4, the body 110 includes a dielectric layer 111, a first internal electrode layer 120a, and a second internal electrode layer 120b alternately disposed in a first direction with the dielectric layer 111 interposed therebetween.

The shape of the body 110 may not be limited to any particular shape, but as illustrated, the body 110 may have a hexahedral shape or a shape similar to a hexahedral shape. Due to reduction of ceramic powder included in the body 110 during a firing process, the body 110 may not have an exact hexahedral shape formed by linear lines but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2 and the third and fourth surfaces 3 and 4 and opposing each other in a third direction.

A plurality of dielectric layers 111 forming the body 110 may be in a sintered state, and a boundary between the adjacent dielectric layers 111 may be integrated with each other such that the boundary may not be readily apparent without a scanning electron microscope (SEM).

A raw material for forming the dielectric layer 111 is not limited to any particular example as long as sufficient capacitance may be obtained. For example, a barium titanate-based material, a lead composite perovskite-based material, or a strontium titanate-based material may be used. The barium titanate material may include BaTiO₃ ceramic powder, and an example of the ceramic powder may include (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca (calcium), Zr (zirconium) is partially dissolved. In this case, the dielectric layer 111 may include barium (Ba) and titanium (Ti), and may additionally include calcium (Ca) and zirconium(Zr) depending on the dissolved elements.

Meanwhile, as the raw material for forming the dielectric layer 111, a CaZrO₃— based paraelectric (Ca₁₋ₓSrₓ)(Zr_{1-y}Ti_{y})O₃ (0<x<1, 0<y<1) (CSZT) material can be used. In this case, the dielectric layer 111 may include calcium (Ca), strontium (Sr), zirconium (Zr), and titanium (Ti).

In addition, the raw material of the dielectric layer 111 may include various ceramic additives, organic solvents, binders, dispersants, and the like, added to powder such as barium titanate (BaTiO₃) powder, or the like, according to an object of the present disclosure.

The first internal electrode layer 120a and the second internal electrode layer 120b may be alternately disposed with the dielectric layer 111 interposed therebetween, so that the first internal electrode layer 120a and the second internal electrode layer 120b may serve to form capacitance together with the dielectric layer 111. However, capacitance may not be formed over the entire area of the first internal electrode layer 120a and the second internal electrode layer 120b, and first internal electrodes 121 and 122 and second internal electrode 122, to be described later, may overlap in the first direction or the third direction, so that capacitance may be formed only in an area in which an electric field is formed and a peripheral area thereof. In this specification, for convenience of explanation, the area in which the first internal electrode 121 and the second internal electrode 122 overlap in the first or third direction is defined as a capacitance forming portion (Ac), but the area in which capacitance is actually formed may be different from the capacitance forming portion (Ac).

In an embodiment, cover portions 112 and 113 may be disposed on one surface and the other surface of the capacitance forming portion Ac in the first direction.

The cover portions 112 and 113 may be formed by stacking a single dielectric layer or two or more dielectric layers on the upper and lower surfaces of the capacitance forming portion Ac in the thickness direction, respectively, and may prevent damages to the internal electrode due to physical or chemical stress.

The cover portions 112 and 113 may not include internal electrodes, and may include the same material as that of the dielectric layer 111. That is, the cover portions 112 and 113 may include a ceramic material, for example, a barium titanate (BaTiO₃) ceramic material.

Meanwhile, an average thickness of the cover portions 112 and 113 may not be limited to any particular example. However, to easily obtain miniaturization and high capacitance of the multilayer electronic component, the average thickness the cover portions 112 and 113 may be 15 μm or less.

Here, the average thickness of the cover portions 112 and 113 may refer to a size of the cover portions 112 and 113 in a first direction, and may be a value obtained by averaging sizes of the cover portions 112 and 113 measured at five points at equal intervals in the first direction above or below the capacitance forming portion Ac.

Referring to FIG. 2, in an embodiment, margin portions 114 and 115 may be disposed on one surface and the other surface of the capacitance forming portion Ac in a third direction.

The margin portions 114 and 115 may mean a region between both ends of the first and second internal electrodes 121 and 122 and an interface of the body 110, as illustrated in FIG. 2.

The margin portions 114 and 115 may basically serve to prevent damages to the internal electrodes due to physical or chemical stress.

The margin portions 114 and 115 may be formed by applying a conductive paste to the ceramic green sheet, except where margin portions are to be formed to form an internal electrode.

In addition, in order to suppress a step by the internal electrodes 121 and 122, after the internal electrodes are cut so as to be exposed to the fifth and sixth surfaces 5 and 6 of the body after lamination, the margin portions 114 and 115 may also be formed by stacking a single dielectric layer or two or more dielectric layers on both side surfaces of the capacitance forming portion Ac in the third direction (width direction).

Meanwhile, a width of the margin portions 114 and 115 is not particularly limited. However, in order to more easily implement miniaturization and high capacitance of the multilayer electronic component, an average width of the margin portions 114 and 115 may be 15 μm or less.

The average width of the margin portions 114 and 115 may refer to an average size of the margin portions 114 and 115 in a third direction, and may be a value obtained by averaging sizes of the margin portions 114 and 115 measured at five points at equal intervals in the third direction in terms of the capacitance forming portion Ac.

The internal electrodes 121 and 122 may be alternately disposed with the dielectric layer 111 therebetween in a first direction, and may also be alternately disposed in a third direction. The internal electrodes 121 and 122 may include a first internal electrode 121 connected to the first external electrode 130 and a second internal electrode connected to the second external electrode 140. In this case, the first internal electrode 121 may be disposed to be spaced apart from the second external electrode 140, and the second internal electrode 122 may be disposed to be spaced apart from the first external electrode 121. Accordingly, different voltages may be applied to the first internal electrode 121 and the second internal electrode 122.

Meanwhile, the dielectric layer 111 may be disposed in a space in which the first internal electrode 121 is spaced apart from a second external electrode 140 to be described later, and in a space in which the second internal electrode 122 is spaced apart from a first external electrode 140 to be described later, and thus mechanical strength and moisture resistance reliability of the multilayer electronic component 100 may be improved.

Referring to FIG. 4, the first internal electrode 121 and the second internal electrode 122 may be alternately disposed to be spaced apart in a third direction within the same internal electrode layers 120a and 120b, and the first internal electrode 121 included in one of the internal electrode layers 120a and 120b may be alternately disposed with the second internal electrode 122 included in the other internal electrode layers in the first direction. Meanwhile, as described above, since the internal electrode layers 120a and 120b are disposed with the dielectric layer 111 interposed therebetween, the first internal electrode 121 included in one of the internal electrode layers 120a and 120b may be disposed to be spaced apart from the second internal electrode 122 included in the other internal electrode layer in the first direction. Likewise, the second internal electrode 122 included in one of the internal electrode layers 120a and 120b may be alternately disposed in the first direction with the first internal electrode 121 included in the other internal electrode layer, and may be disposed to be spaced apart from each other.

The material for forming the internal electrodes 121 and 122 is not limited to any particular example, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof on a ceramic green sheet. A screen printing method or a gravure printing method may be used as a method of printing the conductive paste for internal electrodes, but an embodiment thereof is not limited thereto.

External electrodes 131 and 132 may be disposed on the body 110.

The external electrodes 130 and 140 may include a first external electrode 130 in contact with the third surface 3 of the body 110 and a second external electrode 140 in contact with the fourth surface 4 of the body 110. The first external electrode 130 may be connected to the first internal electrode 121, and the second external electrode 140 may be connected to the second external electrode 122.

In the embodiment, the multilayer electronic component 100 may have two external electrodes 130 and 140, but the number of the external electrodes 130 and 140 and the shape thereof may be varied depending on the internal electrodes 121 and 122 or for other purposes.

Meanwhile, the external electrodes 130 and 140 may be formed of any material having electrical conductivity, such as metal, and a specific material may be determined in consideration of electrical properties and structural stability, and the external electrodes 130 and 140 may have a multilayer structure.

For example, the external electrodes 130 and 140 may include an electrode layer disposed on the body 110 and a plating layer disposed on the electrode layer.

For a more specific example of the electrode layer, the electrode layer may be a sintered electrode including a conductive metal and glass, or a resin-based electrode including a conductive metal and a resin.

In addition, the electrode layer may have a form in which a sintered electrode and a resin-based electrode are sequentially formed on the body. In addition, the electrode layer may be formed by transferring a sheet including a conductive metal onto a body or by transferring a sheet including a conductive metal onto a sintered electrode.

A material having excellent electrical conductivity may be used as the conductive metal included in the electrode layer and the type of the electrode layers is not limited to any particular example. For example, the conductive metal may be one or more of nickel (Ni), copper (Cu), and alloys thereof, and may be preferably copper (Cu) to improve adhesion with the body.

The plating layer serves to improve mounting properties. The type of the plating layers is not limited to any particular example, and may be a plating layer including one or more of nickel (Ni), tin (Sn), palladium (Pd), and alloys thereof, and may be formed of a plurality of layers.

For a more specific example of the plating layers, the plating layer may be a Ni plating layer or a Sn plating layer, the plating layers may have a form in which the Ni plating layer and the Sn plating layer are sequentially formed, and a form in which the Sn plating layer, the Ni plating layer, and the Sn plating layer are sequentially formed. In addition, the plating layer may include a plurality of Ni plating layers and/or a plurality of Sn plating layers.

FIG. 3 is a cross-sectional view illustrating a cross-section of a multilayer electronic component in a first direction and a third direction polished to a central portion of the multilayer electronic component in a second direction according to a comparative example. This structure represents a multilayer electronic component having an internal electrode of a conventional general structure.

Specifically, in the case of the multilayer electronic component according to the comparative example, a capacitance forming portion Ac′ may include a first internal electrode 121′ and a second internal electrode 122′ alternately disposed with a dielectric layer 111′ interposed therebetween. In this case, the first internal electrode 121′ and the second internal electrode 122′ are formed continuously in the second direction or third direction to secure an area in which the internal electrodes are overlapped.

Meanwhile, in the conventional case illustrated in FIG. 3, in order to improve the capacitance per unit volume, a degree of stacking should be improved by reducing the thickness of the dielectric layer 111′ or the internal electrodes 121′ and 122′, and in order to solve deterioration in reliability which occurs in this process, a method such as increasing the number of dielectric grains per layer of the dielectric layer 111′ are used. However, there is a limit to reducing the thickness of the dielectric layer 111′ or the internal electrodes 121′ and 122′ in ultra-small and high-capacitance multilayer electronic component, and there is also a limit to increasing the number of dielectric grains per layer in the thinned dielectric layer.

Referring to FIGS. 4 and 5, structures of the first internal electrode layer 120a and the second internal electrode layer 120b of the multilayer electronic component 100 according to an embodiment of the present disclosure may be confirmed.

Specifically, the first internal electrode layer 120a and the second internal electrode layer 120b include a first internal electrode 121 connected to the first external electrode 130, and a second internal electrode 122 connected to the second external electrode 140. That is, unlike the conventional case, the multilayer electronic component 100 according to an embodiment of the present disclosure may include all internal electrodes connected to different electrodes for each internal electrode layer.

Referring to FIGS. 4 and 5, the first and second internal electrodes 121 and 122 are alternately disposed to be spaced apart in a third direction, perpendicular to the first and second directions. In addition, the first internal electrode 121 of the first internal electrode layer 120a is alternately disposed with the second internal electrode 122 of the second internal electrode layer 120b in the first direction, and the second internal electrode 122 of the first internal electrode layer 120a is alternately disposed with the first internal electrode 121 of the second internal electrode layer 120b in the first direction. Accordingly, density of the internal electrodes contributing to the formation of capacitance can be improved compared to the conventional case shown in FIG. 3, by improving the number of electric field fluxes between the internal electrodes of the multilayer electronic component, the capacitance per unit volume of the multilayer electronic component may be improved.

Hereinafter, disclosure will be made based on the schematic diagram of the internal electrode that the capacitance per unit volume of the multilayer electronic component according to an embodiment of the present disclosure is significantly improved compared to the conventional case due to a difference in the internal electrode structure.

FIG. 7A is a schematic diagram illustrating an electric field flux between internal electrodes of a multilayer electronic component according to a comparative example using a (3×n) matrix as an example, and FIG. 7B is a schematic diagram illustrating an electric field flux between internal electrodes of a multilayer electronic component according to an example using the (3×n) matrix as an example.

It can be shown that the comparative example is a case in which the first and second internal electrodes are formed continuously in the second or third direction, as in the conventional case described above, and the example is a case in which the first and second internal electrodes are formed to be spaced apart in the second or third direction, as in an embodiment of the present disclosure. E shown in FIGS. 7A and 7B refers to an electric field, and a direction of an arrow indicates a direction of the electric field.

Specifically, assuming a (3×n) matrix, and when a stacking degree of the internal electrodes 121′ and 122′ in FIG. 7A is n, according to a comparative example, the total number of electric field fluxes corresponds to 3n. Meanwhile, when a stacking degree of the internal electrodes 121 and 122 in FIG. 7B is n, according to an example, the total number of electric field fluxes corresponds to 3n+1. That is, in the comparative examples and examples, it can be seen that a difference in the number of electric field fluxes according to the internal electrode structure in the same stacking degree is 1.

FIG. 8A is a schematic diagram illustrating an electric field flux between internal electrodes of a multilayer electronic component according to a comparative example using an (n×3) matrix as an example, and FIG. 8B is a schematic diagram illustrating an electric field flux between internal electrodes of a multilayer electronic component according to an example using an (n×3) matrix as an example.

It can be seen that the comparative example is a case in which the first and second internal electrodes are formed continuously in the second or third direction, and the example, as in the conventional case described above, is a case in which the first and second internal electrodes are disposed to be spaced apart in the second or third direction. E shown in FIGS. 8A and 8B refers to an electric field, and a direction of an arrow indicates a direction of the electric field.

Specifically, assuming a (n×3) matrix, if the number of divisions of the internal electrodes 121′ and 122′ in FIG. 8A is n, according to a comparative example, the total number of electric field fluxes corresponds to 2n+1. Meanwhile, if the number of divisions of the internal electrodes 121 and 122 in FIG. 8B is n, the total number of electric field fluxes corresponds to 3n+1 according to an example. That is, in the comparative examples and examples, it can be seen that the difference in the number of electric field fluxes depending on the internal electrode structure at the same number of divisions reaches 50%.

Summarizing the results of FIGS. 7 and 8, as in an embodiment of the present disclosure, when the first and second internal electrodes 121 and 122 are alternately disposed to be spaced apart in a third direction, perpendicular to the first and second directions, the first internal electrode 121 of the first internal electrode layer 120a is alternately disposed with the second internal electrode 122 of the second internal electrode layer 120b in the first direction, and the second internal electrode 122 of the first internal electrode layer 120a is alternately disposed with the first internal electrode 121 of the second internal electrode layer 120b in the first direction, it can be seen that the number of electric field fluxes may be significantly improved as compared to the conventional case, and thus the capacitance per unit volume of the multilayer electronic component 100 may be significantly improved.

In addition, summarizing the results of FIGS. 7 and 8, it can be seen that the number of internal electrodes overlap of the number of the number of divisions of the internal electrodes in the third direction (in the width direction of the electrode layer) is more important for improving the capacitance per unit volume of the multilayer electronic component 100 than the stacking degree of the internal electrodes in the first direction (the stacking direction of the electrode layer). That is, when the stacking degree of the first internal electrode 121 and the second internal electrode 122 in the third direction is higher than the stacking degree of the first internal electrode 121 and the second internal electrode 122 in the first direction, it may be more advantageous to improve the capacitance per unit volume of the multilayer electronic component.

Here, the stacking degree thereof in the first direction may mean the number of the first internal electrode 121 and the second internal electrode 122 overlapping in the first direction, and the stacking degree thereof in the third direction may mean the number of the first internal electrode 121 and the second internal electrode 122 overlapping in the third direction. That is, in an embodiment, the number of the first internal electrodes 121 and the second internal electrodes 122 overlapping in the third direction may be more than the number of the first internal electrodes 121 and the second internal electrodes 122 overlapping in the first direction.

Meanwhile, referring to FIG. 4, the first internal electrode 121 and the second internal electrode 122 according to an embodiment may be disposed in a lattice shape in the cross-section of the multilayer electronic component 100 in the first and third directions. Accordingly, the capacitance per unit volume of the multilayer electronic component may be improved by improving the number of electric field fluxes between the internal electrodes of the multilayer electronic component.

The shape of the lattice structure and the positions in which the internal electrodes 121 and 122 are disposed are not particularly limited as long as they satisfy an embodiment of the present disclosure. As an example, the first internal electrode layer 120a and the second internal electrode layer 120b may include a plurality of first internal electrodes 121 and a plurality of second internal electrodes 122, and an internal electrode most adjacent to one of the plurality of first internal electrodes have a form the same as the second internal electrode 122. Accordingly, by increasing the number of electric field fluxes formed between the internal electrodes 121 and 122, the capacitance per unit volume of the multilayer electronic component 100 may be significantly improved.

Meanwhile, as in an embodiment of the present disclosure, a method for forming a structure in which the first internal electrode 121 and the second internal electrode 122 are alternately disposed to be spaced apart in a third direction, perpendicular to the first and second directions, the first internal electrode 121 of the first internal electrode layer 120a is alternately disposed with the second internal electrode 122 of the second internal electrode layer 120b in the first direction, and the second internal electrode 122 of the first internal electrode layer 120a is alternately disposed to be spaced apart in the first direction with the first internal electrode 121 of the second internal electrode layer 120b is not particularly limited. As shown in FIG. 10, both a conductive pattern 221 for forming the first internal electrode and a conductive pattern 222 for forming the second internal electrode may be formed on a dielectric ceramic green sheet 211, and stacked, pressed, and sintered to form the conductive patterns. The conductive pattern 221 for forming the first internal electrode and the conductive pattern 222 for forming the second internal electrode may be formed by printing, but the present disclosure is not limited thereto, and the conductive pattern may be formed by attaching a one-dimensional conductive material continuous in the second direction to a dielectric ceramic green sheet 211. The conductive pattern 222 for forming the second internal electrode may be formed by attaching a one-dimensional conductive material continuous in the second direction to the dielectric ceramic green sheet 211.

Meanwhile, the first internal electrode 121 and the second internal electrode 122 may be alternately disposed to be spaced apart in a third direction, perpendicular to the first and second direction, the first internal electrode 121 of the first internal electrode layer 120a is alternately disposed in the first direction with the second internal electrode 122 of the second internal electrode layer 120, and the second internal electrode 122 of the first internal electrode layer 120a is alternately disposed in the first direction with the first internal electrode 121 of the second internal electrode layer 120b, which may improve the capacitance per unit volume of the multilayer electronic component 100, but it may be difficult to secure reliability. In order to improve reliability such as withstand voltage characteristics in an internal electrode structure such as an embodiment of the present disclosure, various parameters such as the relative position and thickness of the dielectric layer 111, the first internal electrode 121, and the second internal electrode 122 need to be adjusted.

FIG. 9 is an enlarged view of area P in FIG. 4.

Referring to FIG. 9, a distance in a third direction between a first internal electrode 121 and a second internal electrode, most adjacent to the first internal electrode in the third direction was indicated as “s”. The distance “s” in the third direction between the first internal electrode 121 and the second internal electrode, most adjacent to the first internal electrode in the third direction may refer to a distance of line segments in the third direction obtained by connecting one end of the first internal electrode 121 in the third direction and one end opposed thereto, among one end of the first internal electrode 121 in the third direction and one end of the second internal electrode 122 in the third direction, in a cross-section in the first and third directions polished to a central portion of the multilayer electronic component 100 in the second direction, and may be measured using a scanning electron microscope (SEM) or an optical microscope (OM), but the present disclosure is not limited thereto.

The distance “s”, in the cross-section in the first and third directions polished to the central portion of the multilayer electronic component 100 in the second direction, may have an average value of values measured in the central portion of the capacitance forming portion, which is adjusted so that 10 or more layers of first and second internal electrodes are provided, respectively in the first direction, so that it can be further generalized. That is, “s” may be an average distance in the third direction between the first internal electrode 121 and the second internal electrode 122, most adjacent to the first internal electrode 121 in the third direction.

Referring to FIG. 9, a distance in a first direction between a first internal electrode and a second internal electrode 122, most adjacent to the first internal electrode in the first direction was indicated as “td”. The distance “td” in the first direction between the first internal electrode 121 and the second internal electrode 122, most adjacent to the first internal electrode in the first direction refers to a distance of line segments in the first direction obtained by connecting one end of the first internal electrode 121 in the first direction and one end opposed thereto, among one end of the first internal electrode 121 in the first direction and one end of the second internal electrode 122 in the first direction, in a cross-section in the first and third directions polished to a central portion of the multilayer electronic component 100 in the second direction, and may be measured using a scanning electron microscope (SEM) or an optical microscope (OM), but the present disclosure is not limited thereto.

The distance “td”, in the cross-section in the first and third directions polished to the central portion of the multilayer electronic component 100 in the second direction, may have an average value of values measured at 10 or more layers of internal electrodes in the central portion of the capacitance forming portion, which is adjusted so that 10 or more layers of first and second internal electrodes are provided, respectively in the first direction, so that it can be further generalized. That is, the distance “td” may be an average distance in the first direction between the first internal electrode 121 and the second internal electrode 122, most adjacent to the first internal electrode in the first direction.

Referring to FIG. 9, a maximum size of the first internal electrode 121 and the second internal electrode 122 in the first direction was indicated as “te”, and a maximum size thereof in the third direction was indicated as “we”. Depending on the specific shapes of the first and second internal electrodes 121 and 122, the thickness and width of the first and second internal electrodes 121 and 122 may be different in each position, so in the present disclosure, the first and second internal electrodes 121 and 122, values corresponding to the thickness and width of the first and second internal electrodes 121 and 122 is set to be the maximum size “te” of the first and second internal electrodes 121 and 122 in the first direction, and the maximum size “we” thereof in the third direction, respectively. Specifically, when described based on the first internal electrode 121, in the cross-section of the multilayer electronic component 100 in the first and third directions polished to the central portion of the multilayer electronic component 100 in the second direction, a size of a line segment obtained by connecting the highest point and the lowest point in the first direction from any one first internal electrode included in the capacitance forming portion may be set to be the maximum size of the first internal electrode 121 in the first direction “te”, and a size of a line segment obtained by connecting outermost points in the third direction (maximum point in the +direction, maximum point in the − direction) from any one first internal electrode may be set to be the maximum size of the first internal electrode 121 in the third direction “we”. This measurement may be similarly applied to the second internal electrode 122, and can be measured using a scanning electron microscope (SEM) or an optical microscope (OM), but the present disclosure is not limited thereto.

In the cross-section of the multilayer electronic component 100 in the first and third directions polished to the central portion of the multilayer electronic component 100 in the second direction, the maximum sizes “te” and “we” may have an average value of values measured at 10 or more internal electrodes in the central portion of the capacitance forming portion, which is adjusted so that 10 or more layers of first and second internal electrodes are provided, respectively in the first direction, so that it can be further generalized. That is, “te” may refer to an average value of the maximum size of the first and second internal electrodes in the first direction, and “we” may refer to an average value of the maximum size of the first and second internal electrodes in the third direction.

In an embodiment, s≥td may be satisfied. When the distance “s” in the third direction between the first internal electrode and the second internal electrode, most adjacent to the first internal electrode in the third direction is smaller than the distance “s” in the first direction between the first internal electrode and the second internal electrode, most adjacent to the first internal electrode in the first direction, when a high voltage is applied to the multilayer electronic component, there may be a risk that a failure may occur between the first internal electrode and a second internal electrode, most adjacent to the first internal electrode in the third direction. Accordingly, in an embodiment, the capacitance per unit volume of the multilayer electronic component 100 may be improved and the withstand voltage characteristics may be improved by adjusting the distance between internal electrodes adjacent in the third direction to be equal to or wider than the distance between internal electrodes adjacent in the first direction. On the other hand, when the dielectric layer is formed of a thin film, such as when “s” or “td” is 0.41 μm or less, when a high voltage is applied to the multilayer electronic component, a reliability problem may become more severe due to a failure occurring in the distance “s” between the first internal electrode and the second internal electrode most adjacent to the first internal electrode in the third direction. However, in an embodiment, by satisfying s≥td, since the withstand voltage characteristics in the third direction is improved, which plays a further important role in capacitance formation, even “s” or “td” is adjusted to be 0.41 μm or less, the withstand voltage characteristics of the multilayer electronic component 100 may be secured. That is, the reliability improvement effect according to an embodiment may be more prominent when “s” or “td” is 0.41 m or less.

In an embodiment, te≤td may be satisfied. When a maximum size “te” of the first and second internal electrodes 121 and 122 is greater than the distance “td” between the first internal electrode and the second internal electrode, most adjacent to the first internal electrode in the first direction, a Fringing Effect may easily occur in the internal electrode. This fringing effect may cause interference with an electric field generated between the first internal electrode 121 and the second internal electrode 122 in the capacitance forming portion, thereby lowering capacitance per unit volume of the multilayer electronic component 100. Accordingly, in an embodiment, by adjusting the maximum size “te” of the first and second internal electrodes 121 and 122 to be equal to or smaller than the distance “td” in the first direction between the first internal electrode and a second internal electrode most adjacent to the first internal electrode in the first direction, the capacitance per unit volume of the multilayer electronic component 100 may be further improved.

In the cross-section in the first direction and third direction, the shape of the internal electrodes 121 and 122 is not particularly limited, and the internal electrodes 121 and 122 may have a shape such as a polygon, regular polygon, circle, or oval.

In an embodiment, 0.5≤te/we≤1.5 may be satisfied, and more preferably 0.9≤te/we≤1.1 may be satisfied. Accordingly, by controlling the shapes of the first and second internal electrodes 121 and 122 to efficiently dispose the first and second internal electrodes 121 and 122 in the capacitance forming portion, the capacitance per unit volume of the multilayer electronic component 100 can be further improved. In this case, when 0.9≤te/we≤1.1 is satisfied, it can be seen that the first internal electrode 121 and the second internal electrode 122 have a substantially square shape in a cross-section thereof in the first and third directions.

Meanwhile, a case in which there are a total of 12 internal electrode layers is shown in FIG. 5, but an embodiment of the present disclosure is not limited thereto. As shown in FIG. 6, the number of internal electrodes may be arranged to be 50 or more layers in the first direction and 50 or more layers in the third direction. Accordingly, the number of electric field fluxes formed between the first internal electrode 121 and the second internal electrode 122 may be significantly improved. Accordingly, in an embodiment, when the maximum size of the body 110 in the first direction is T, 50(te+td)≤T may be satisfied, and accordingly, the first internal electrode layer 120a and the second internal electrode layer 120b may each be disposed in 25 or more layers in the first direction. From a similar perspective, when the maximum size of the body 110 in the third direction is W, 50(s+te)≤W may be satisfied, and accordingly, the first internal electrode 121 and the second internal electrode 122 may be disposed in 25 or more layers in the third direction.

It may not be necessary to specifically limit the size of the multilayer electronic component 100.

However, in order to obtain miniaturization and high capacitance at the same time, to increase the number of laminations by reducing the thickness of the dielectric layer and internal electrode, it may be difficult to secure reliability in the multilayer electronic component 100 having a size of 0201 (length×width, 0.2 mm×0.1 mm) or less.

Accordingly, considering manufacturing errors and the size of external electrode, when the length of the multilayer electronic component 100 is 0.22 mm or less and the width is 0.11 mm or less, the effect of improving reliability according to the embodiment may be more significant.

Here, the length of the multilayer electronic component 100 may refer to the maximum size of the multilayer electronic component 100 in the second direction, and the width of the multilayer electronic component 100 may refer to the maximum size of the multilayer electronic component 100 in the third direction.

As set forth above, according to the aforementioned embodiments, by improving the degree of integration of the electric field, the capacitance per unit volume may be improved.

According to the aforementioned embodiments, in the internal electrode structure to improve the degree of integration of the electric field, the capacitance per unit volume may be improved without deteriorating reliability.

While the example embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer, a first internal electrode layer, and a second internal electrode layer alternately disposed in a first direction, with the dielectric layer interposed therebetween;
a first external electrode disposed on one surface of two surfaces of the body opposing each other in a second direction, perpendicular to the first direction; and
a second external electrode disposed on the other surface of two surfaces of the body opposing each other in the second direction,
wherein the first internal electrode layer and the second internal electrode layer include first internal electrodes connected to the first external electrode, and second internal electrodes connected to the second external electrode,
wherein the first and second internal electrodes are alternately disposed to be spaced apart from each other in a third direction, perpendicular to the first and second directions, the first internal electrodes of the first internal electrode layer are alternately disposed with the second internal electrodes of the second internal electrode layer in the first direction, and the second internal electrodes of the first internal electrode layer are alternately disposed with the first internal electrodes of the second internal electrode layer in the first direction,
wherein s≥td is satisfied, in which s is a distance in the third direction between one of the first internal electrodes and a second internal electrode, most adjacent to the one of the first internal electrodes in the third direction and td is a distance in the first direction between the one of the first internal electrodes and a second internal electrode, most adjacent to the one of the first internal electrodes in the first direction.

2. The multilayer electronic component of claim 1, wherein 0.5≤te/we≤1.5 is satisfied, in which te is a maximum size in the first direction of the one of the first internal electrode and the second internal electrode which is most adjacent to the one of the first internal electrodes in the first direction and we is a maximum size in the third direction of the one of the first internal electrodes and the second internal electrode which is most adjacent to the one of the first internal electrodes in the third direction.

3. The multilayer electronic component of claim 1, wherein te≤td is satisfied, in which te is a maximum size in the first direction of the one of the first internal electrode and the second internal electrode which is most adjacent to the one of the first internal electrodes in the first direction.

4. The multilayer electronic component of claim 1, wherein 50(te+td)≤T is satisfied, in which te is a maximum size in the first direction of the one of the first internal electrode and the second internal electrode which is most adjacent to the one of the first internal electrodes in the first direction and T is a maximum size of the body in the first direction.

5. The multilayer electronic component of claim 1, wherein 50(s+te)≤W is satisfied, in which te is a maximum size in the first direction of the one of the first internal electrode and the second internal electrode which is most adjacent to the one of the first internal electrodes in the first direction and W is a maximum size of the body in the third direction.

6. The multilayer electronic component of claim 1, wherein the first internal electrodes and the second internal electrodes are disposed in an amount of 25 or more layers in the first direction, respectively.

7. The multilayer electronic component of claim 1, wherein the first internal electrodes and the second internal electrodes are disposed in an amount of 25 or more layers in the third direction, respectively.

8. The multilayer electronic component of claim 1, wherein the number of first internal electrodes and second internal electrodes overlapping in the third direction is greater than the number of first internal electrodes and second internal electrodes overlapping in the first direction.

9. The multilayer electronic component of claim 1, wherein the first internal electrodes and the second internal electrodes are disposed in a lattice shape in a cross-section of the multilayer electronic component in the first and third directions.

10. The multilayer electronic component of claim 1, wherein the first internal electrodes and the second internal electrodes have a substantially square shape in the cross-section of the multilayer electronic component in the first and third directions.

11. The multilayer electronic component of claim 1, wherein the first internal electrodes are spaced apart from the second external electrode, and the second internal electrodes are spaced apart from the first external electrode.

12. The multilayer electronic component of claim 11, wherein the dielectric layer is disposed in a space in which the first internal electrodes are spaced apart from the second external electrode and in a space in which the second internal electrodes are spaced apart from the first external electrode.

13. The multilayer electronic component of claim 1, wherein the first internal electrode layer and the second internal electrode layer comprise a plurality of first internal electrodes and a plurality of second internal electrodes, and
an internal electrode, most adjacent to the one of the first internal electrodes, is a second internal electrode.

14. The multilayer electronic component of claim 1, wherein the dielectric layer includes Ba and Ti.

15. The multilayer electronic component of claim 1, wherein the dielectric layer includes calcium (Ca), strontium (Sr), zirconium (Zr), and titanium (Ti).
